(19) United States
(12) Patent Application Publication
(10) Pub. No.: US 2007/0159468 A1
(43) Pub. Date: Jul. 12, 2007

(54) Touchpad control of character actions in a virtual environment using gestures

(76) Inventors: Don T. Saxby, Salt Lake City, UT (US); Richard D. Woolley, Orem, UT (US)

Correspondence Address: MORRISS O''BRYANT COMPAGNI, P.C., 734 E. 200 S., SALT LAKE CITY, UT, 84102, US

(21) Appl. No.: 11/652,389

(22) Filed: Jan. 10, 2007

Related U.S. Application Data
(60) Provisional application No. 60/757,711, filed on Jan. 10, 2006.

(51) Int. Cl. G06F 3/041

(52) U.S. Cl. 345/173

(57) ABSTRACT

A touchpad that shows a representation of at least a portion of a virtual or real object, wherein the touchpad can be used to select a portion of the virtual or real object, such as an appendage or appendages, or the entire virtual or real object, and wherein the touchpad can then be used to give a command regarding an action and/or movement that is to be performed by or on the virtual or real object by using a gesture or combination of gestures on the touchpad surface.

### CROSS REFERENCE TO RELATED APPLICATIONS

This document claims priority to, and incorporates by reference all of the subject matter included in the provisional patent application docket number 3581.CIRQ.PR, having Ser. No. 60/757,711 and filed on Jan. 10, 2006.

### BACKGROUND OF THE INVENTION

1. Field of the Invention

This invention relates generally to touchpads and using touchpad gesturing for input to the touchpad. More specifically, gestures made by a finger on the surface of the touchpad are used to control specific movements and/or actions of objects in a real or a virtual environment.

2. Description of Related Art

Virtual environments that can now be displayed by computers, game consoles and other processing devices are becoming more complex and realistic. The realism of virtual environments, for example in games, can not only be attributed to the ever-increasing processing power available, but to the ability to program interactions within the virtual environment.

Consider a three-dimensional character or vehicle moving about within a virtual game environment. In today's gaming worlds, this character may need to be able to use various weapons, wave a magic wand, fight using bare hands, move a particular limb or limbs, or all of these different types of actions. A virtual vehicle may need to activate or use a particular weapon, extend a particular appendage, perform a series of movements, or perform a combination of movements, actions, firing of weapons, etc. What should be evident is that users want and virtual environments are now providing more ways to interact with those environments. In games, players do not want to be limited by the controller that they are using to work within the virtual environment. Such control requires more sophisticated input capabilities than is available using existing input devices.

Accordingly, it would be an advantage over the state of the art in game control or virtual environment input devices to be able to have faster, more intuitive methods and systems for interacting with a virtual environment. More specifically for a gaming environment where a user is controlling a virtual character, vehicle or other object, it would be an advantage to provide improved methods and systems for controlling the movement of specific limbs in a manner that is both rapid and simple, as well as performing specific actions of the virtual character.

### BRIEF SUMMARY OF THE INVENTION

It is an object of the present invention to provide a touchpad that enables selection portion of a real or virtual object.

It is another object to provide a touchpad that enables rapid input of instructions for controlling the selected portion of the real or virtual object.

In a virtual environment such as a gaming environment, it is an object of the present invention to provide a touchpad that enables selection of a specific appendage or appendages of a virtual character, vehicle or other object.

In a preferred embodiment, the present invention is a touchpad that shows a representation of at least a portion of a virtual or real object, wherein the touchpad can be used to select a portion of the virtual or real object, such as an appendage or appendages, or the entire virtual or real object, and wherein the touchpad can then be used to give a command regarding an action and/or movement that is to be performed by or on the virtual or real object by using a gesture or combination of gestures on the touchpad surface.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a top view of a touchpad that displays the outline of a virtual character that is being controlled by gestures or gestures and buttons on the touchpad.

FIG. 2 is a top view of a touchpad that displays the outline of a hand of the virtual character that is being controlled.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

The present invention is a system and method for enabling faster and more precise control of a virtual object. This virtual object is most likely to be found within a virtual environment, but may be a stand-alone object. The virtual object can be many different things. For example, the virtual object may be a virtual human or humanoid character, some other alien or fantasy life form that does not resemble a human, or even a vehicle of some type. What is important to realize is that the present invention can be adapted to control the movement or actions of any object or character.

Furthermore, the present invention is not limited to virtual objects or environments. While the examples above have focused on virtual characters and environments, it should also be understood that the present invention can be used in other applications. For example, an actual robot or robotic appliance used in industry can also be controlled using the method and system of the present invention. For example, a robot used on an assembly line, or a robotic appliance being used in a remotely operated medical environment, or a robotic appliance on the International Space Station can all be controlled using the method and system of the present invention. The essence of the invention is the ability to remotely control an object or device in an efficient and rapid manner, in a real or virtual environment.

Throughout this document, a virtual character is used for the purpose of examples. However, it should be understood that the virtual character with its limbs, appendages or weapons can be substituted by various virtual or real objects with different limbs, appendages or weapons, and should not be considered a limiting factor for the purpose of claims.

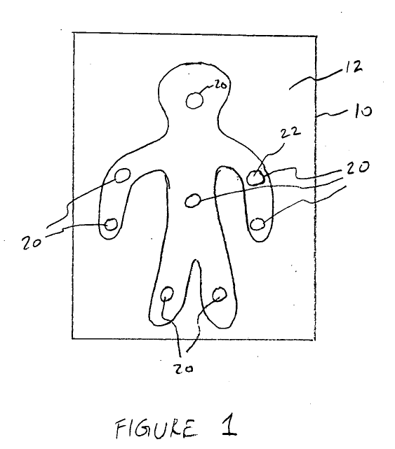

In a first embodiment of the present invention, FIG. 1 is a top view of the surface of a touchpad 10. The touchpad surface 12 shows the outline 14 of a human-like virtual character 16 that is being controlled by input from the touchpad 10. The outline 14 is not meant to be representative of the actual appearance of the virtual character 16, but only to represent various limbs and/or body parts. The outline of the virtual character can obviously be changed to represent whatever object is being controlled.

The display of the virtual character 16 on the touchpad surface 12 can be accomplished in various ways. In one embodiment, the virtual character 16 is shown as an overlay that is disposed on the touchpad surface 12. The overlay may be removed and replaced as necessary.

In an alternative embodiment, the touchpad surface 12 is at least partially transparent, and is disposed on top of a display screen that is visible through the touchpad surface 12. In one embodiment, the display screen is a liquid crystal display (LCD) that is programmed to display the virtual character 16.

While the LCD display may show a simple outline of the virtual character 16, in another embodiment, the LCD display can also show a more detailed or realistic representation of the virtual character 16.

In one embodiment of the invention, the outline of the virtual character 16 does not change. A user will select a limb or body part shown in the touchpad surface 12. Selection could be performed by a simple touch action, or a more involved process such as a double tap or other combination of touching and/or gestures. What is important is that the user be able to select whatever portion of the virtual character 16 that needs to be controlled, such as a limb, body part or the entire virtual character 16.

Alternatively, it may not be necessary to select the virtual character 16 if the particular command to be input is specific to the entire virtual character 16, or to a unique or specific portion of the virtual character.

Once the selection has been made, the user will then input a command. The command might be instructions to be performed by the virtual character 16, or for an action to be performed on the virtual character. Other commands might be movement or action to be performed by a portion of or the entire virtual character 16.

For example, a user may select the virtual character's left arm by touching the touchpad surface near a zone 20 or area of contact that is used to designate the virtual character's left arm. In this case, if the virtual character 16 is assumed to be facing outwards on the overlay or LCD display screen, then the user would make the appropriate action using the zone 20 indicated as 22.

Any touching or combination of touching and/or movements that take place within a specific zone 20 will result in a selection of a limb, body part or even the entire virtual character 16. These zones 20 may be displayed on the overlay or LCD display screen. The zones can change to reflect the condition of the virtual character 16. Thus, the user can be given feedback regarding the condition of the virtual character 16. Some portions of the virtual character 16 may become unavailable due to damage in a combat environment, and these could be indicated by the portion being made a different color or by other visual indicator on the display.

Once the selection has been made, or if a selection does not need to be made, the user is ready to input a command so that some action will be performed by the limb, body part, or the entire virtual character 16.

In order to input commands rapidly, it is an aspect of the present invention that gestures can be used. Gestures can be taps, combinations of taps, touchdown, liftoff, short and rapid movements of a pointing object touching and/or moving along the touchpad surface, and any conceivable combination of taps touchdowns, liftoffs, and movements in any order. In other words, a pointing object such as a user's finger is used to touch and typically move along the touchpad surface. By using easily remembered gestures, commands can be input more rapidly and efficiently to thereby enhance game play and shorten response time of the user, or be used to send more involved and complex instructions that incorporate combinations of movements and actions.

Gestures are an important aspect of the present invention because they are inherently easy to remember, and thus should enable rapid input to a touchpad. For example, a gesture can be a symbol. Consider a number “#” sign, a carat “ˆ”, an open parentheses “(”, and a plus “+” sign. These symbols can be simple gestures that do not require the user to lift a finger from the touchpad surface 12, or they can be distinct and separate movements that require lifting the finger from the touchpad surface.

In another aspect of the present invention, a sequence of gestures can also be combined together and result in a sequence of commands being sent to control the virtual character 16. For example, a virtual character 16 can be sent the commands to do a series of attacks in sequence. For example in martial arts, the virtual character 16 can be instructed to do a spin, then a backhand, a punch, and then a roundhouse kick. These four techniques could be input to the touchpad by inputting the gestures ˆ, +, −, and (on the touchpad surface 12, and then pressing a button or a final gesture that instructs the virtual character 16 to perform the sequence of techniques.

More specifically, consider a selected left arm of the virtual character 16. The user might send a command to the virtual character 16 to strike with a weapon in the left hand, raise a wand and perform a specific spell using the left arm, form a fist and strike using the left arm, form a knife-hand and strike using the left arm, reach out to a door and open the door using the left arm, reach out and pick up an object using the left arm, grab an opponent with the left arm, etc. What should be understood is that the possible commands that can be given to the virtual character through a gesture or combination of gestures and/or buttons are many. To make the input of these commands a fast process, the user will perform a unique gesture or gestures on the touchpad surface 12.

Possible gestures that can be performed are limited only by the software that is tracking movement of the user's finger across the touchpad surface 12. It is an aspect of the present invention that touchpads manufactured using CIRQUE® Corporation technology are capable of tracking and advanced gesture recognition. In one embodiment, the gesture can be a simple and relatively straight line that is horizontal, vertical or diagonal from right to left or left to right across the touchpad surface 12. A vertical line down the middle of the touchpad surface 12 might be interpreted as a different command from a vertical line down the right or left sides. Moving from top to bottom might be a different command than moving from bottom to top of the touchpad surface 12. In another embodiment, the gesture can be a combination of straight but connected lines. In another embodiment, the gesture can include at least two movements across the touchpad surface, but interrupted by a user lifting the pointing object off the touchpad surface 12 for a period of time, and then setting the pointing object back down on the touchpad surface before continuing movement of the pointing object. In another embodiment the gesture can include arcuate movements alone, or in combination with straight lines and/or lift-offs and set-downs of the pointing object.

For even more specific manipulation of the virtual character 16, another aspect of the present invention is that after selecting a specific limb, more detailed selection is also possible before a command is given. For example, consider a left arm of the virtual character 16 being selected. An LCD display under the touchpad 10 might then change the view of the virtual character 16 being displayed to show a close-up of the left hand.

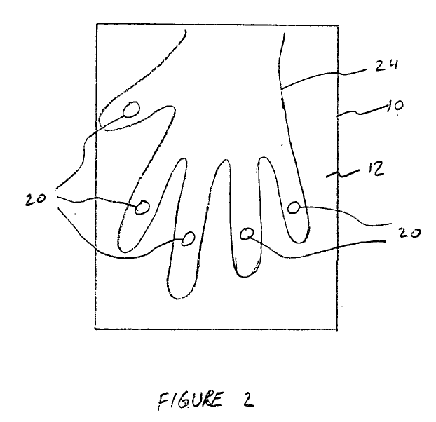

As shown in FIG. 2, the left hand 24 is now displayed, wherein each finger of the left hand now has a zone 20 that must be actuated in order to send a command to a specific digit of the hand.

In another embodiment of the present invention, the virtual character 16 has jointed limbs such that the limbs can be moved at specific joints.

In another embodiment, mechanical buttons or virtual touchpad buttons on the touchpad surface 12 can be used to send commands. For example, a user selects a left arm. The user can either input a command to be performed by the left arm, or touch a button to cause the display to change and focus in on a smaller feature of the left arm, such as the left hand, before a command is input, or back out from a specific limb to the entire virtual character, or the vehicle in which the virtual character is disposed.

In another embodiment of the present invention, the virtual character 16 displayed on the LCD display screen under the touchpad surface 12 can be caused to move to reflect the action that the user is causing to take place. For example, the virtual character 16 can move the left arm when the left arm is selected and a command is given to move the arm.

In another aspect, a limb of the virtual character 16 on the LCD display screen moves when the user gives a command using a gesture. For example, the user selects the left arm, and then drags the arm to cause a command to be sent regarding an action to be performed by the left arm. Thus, a specific object can be selected and then the object is touched in a certain location or moved in a certain manner to thereby send instructions to be performed by the object.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method of sending commands to control a virtual character in a virtual environment using gestures on a touchpad, said method comprising the steps of:
(1) providing a touchpad that receives input by detecting and tracking touchdown and movement of a pointing object on a surface thereof;
(2) performing a gesture on a touchpad surface;
(3) identifying which gesture was performed on the touchpad surface;
(4) correlating the identified gesture to a command for controlling a virtual character.

2. The method as defined in claim 1 wherein the method further comprises the step of executing the command corresponding to the identified gesture for the virtual character.

3. The method as defined in claim 1 wherein the method further comprises the step of selecting the command from the groups of commands comprised of actions and movements that can be performed by the virtual character.

4. The method as defined in claim 1 wherein the method further comprises the step of selecting the gesture from the group of gestures on a touchpad surface comprised of touchdown, liftoff, tap, double tap, touchdown and movement, a single movement, a combination of taps and movements, and a combination of movements interrupted by liftoff and touchdown.

5. The method as defined in claim 1 wherein the method further comprises the step of providing a visual overlay on the touchpad surface that corresponds to the virtual character.

6. The method as defined in claim 1 wherein the method further comprises the step of disposing the touchpad on a display screen, wherein the display screen is visible through the touchpad.

7. The method as defined in claim 6 wherein the method further comprises the step of displaying the virtual character on the display screen.

8. The method as defined in claim 7 wherein the method further comprises the step of causing the virtual character on the display screen to reflect actions or movements being performed by or on the virtual character.

9. A method of controlling a virtual object in a virtual environment using gestures on a touchpad, said method comprising the steps of:
(1) providing a touchpad that receives input by detecting and tracking touchdown and movement of a pointing object on a surface thereof;
(2) performing a gesture on a touchpad surface;
(3) identifying which gesture was performed on the touchpad surface;
(4) correlating the identified gesture to a command for controlling a virtual object.

10. The method as defined in claim 1 wherein the method further comprises the step of executing the command corresponding to the identified gesture for the virtual object.

11. The method as defined in claim 1 wherein the method further comprises the step of selecting the command from the groups of commands comprised of selecting a portion of the virtual object, selecting the virtual object, performing an action by the virtual object, performing an action on the virtual object, performing movement by a selected portion of the virtual object and performing movement by all of the virtual object.

12. The method as defined in claim 1 wherein the method further comprises the step of selecting the virtual object from the groups of virtual objects comprised of characters, vehicles, and weapons.

13. A method of remotely operating a device using gestures on a touchpad, said method comprising the steps of:
(1) providing a touchpad that receives input by detecting and tracking touchdown and movement of a pointing object on a surface thereof;
(2) performing a gesture on a touchpad surface;
(3) identifying which gesture was performed on the touchpad surface;
(4) correlating the identified gesture to a command for remotely operating a device.

14. The method as defined in claim 1 wherein the method further comprises the step of executing the command corresponding to the identified gesture for remotely controlling the device.

15. The method as defined in claim 1 wherein the method further comprises the step of selecting the command from the groups of commands comprised of actions and movements that can be performed by the device.

16. A system for remotely controlling a virtual object using gestures on a touchpad, said system comprised of:
a touchpad that receives input by detecting and tracking touchdown and movement of a pointing object on a surface thereof;
means for identifying a gesture that is performed on a surface of the touchpad; and
means for correlating the identified gesture to a command for controlling a virtual object.

17. A system for remotely controlling a real object using gestures on a touchpad, said system comprised of:
a touchpad that receives input by detecting and tracking touchdown and movement of a pointing object on a surface thereof;
means for identifying a gesture that is performed on a surface of the touchpad; and
means for correlating the identified gesture to a command for controlling a real object.
